(19) United States
(12) Patent Application Publication
(10) Pub. No.: US 2015/0284999 A1
(43) Pub. Date: Oct. 8, 2015

(54) Apparatus for Damping a Reel

(71) Applicant: Tai-Ping LIU, TAICHUNG (TW)

(72) Inventor: Tai-Ping LIU, TAICHUNG (TW)

(21) Appl. No.: 14/243,328

(22) Filed: Apr. 2, 2014

(51) Int. Cl. E06B 9/80

(52) U.S. Cl. CPC E06B 9/80

(57) ABSTRACT

A reel-damping apparatus includes two tubes and a ring. The first tube includes an internal thread and an internal frusto-conical face formed with a small end and a large end. The second tube includes an external thread engaged with the internal thread when the second tube is inserted in the first tube. The ring is mounted on the second tube. The ring is in tighter contact with the first tube against the rotation of the first tube on the second tube as the ring is located at the small end of the frusto-conical face than at the large end of the frusto-conical face.

### BACKGROUND OF INVENTION

1. Field of Invention

The present invention relates to a reel for a Roman blind and, more particularly, to a reel-damping apparatus.

2. Related Prior Art

A Roman blind can be supported on a conventional rolling apparatus that includes a reel and a rope. The Roman blind includes an upper edge tied to the reel. The rope is connected to the reel. The rope is pulled to rotate the reel to reel or release the Roman blind. The reeling of the Roman blind is inconvenient.

The Roman blind can be supported on a rolling apparatus that includes a reel, a rope, a shaft and a spring. The upper edge of the Roman blind is tied to the reel. The rope is connected to the reel. The shaft is inserted in the reel. The spring is provided between the shaft and the reel. The rope is pulled to rotate the reel to release the Roman blind and at the same time load the spring. The Roman blind can be reeled by the spring automatically if so desired. The reeling of the Roman blind is however fast and hence dangerous.

Therefore, the present invention is intended to obviate or at least alleviate the problems encountered in prior art.

### SUMMARY OF INVENTION

It is the primary objective of the present invention to provide a Roman blind with a reel-damping apparatus.

To achieve the foregoing objective, the reel-damping apparatus includes two tubes and a ring. The first tube includes an internal thread and an internal frusto-conical face formed with a small end and a large end. The second tube includes an external thread engaged with the internal thread when the second tube is inserted in the first tube. The ring is mounted on the second tube. The ring is in tighter contact with the first tube against the rotation of the first tube on the second tube as the ring is located at the small end of the frusto-conical face than at the large end of the frusto-conical face.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is an exploded, cut-away view of a reel-damping apparatus according to the preferred embodiment of the present invention;

FIG. 2 is an exploded, cut-away view of a reel including the reel-damping apparatus shown in FIG. 1;

FIG. 3 is a partial, cross-sectional view of the reel of FIG. 2; and

FIG. 4 is a partial, cross-sectional view of the reel in another position than shown in FIG. 3.

### DETAILED DESCRIPTION OF PREFERRED EMBODIMENT

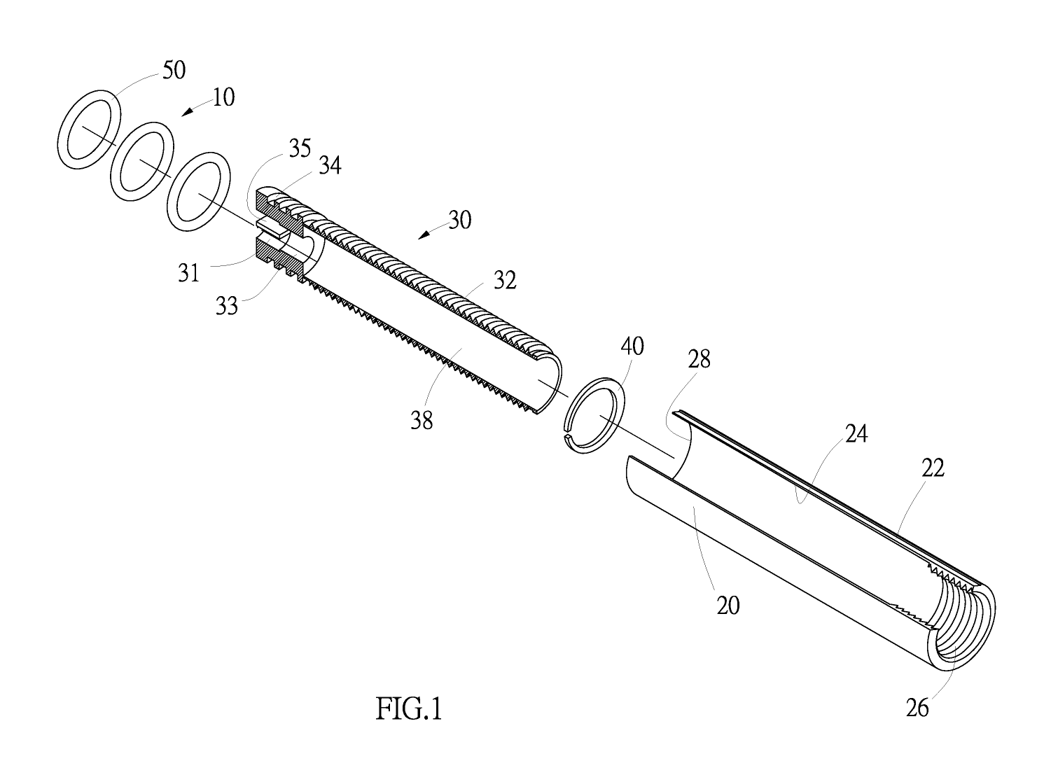

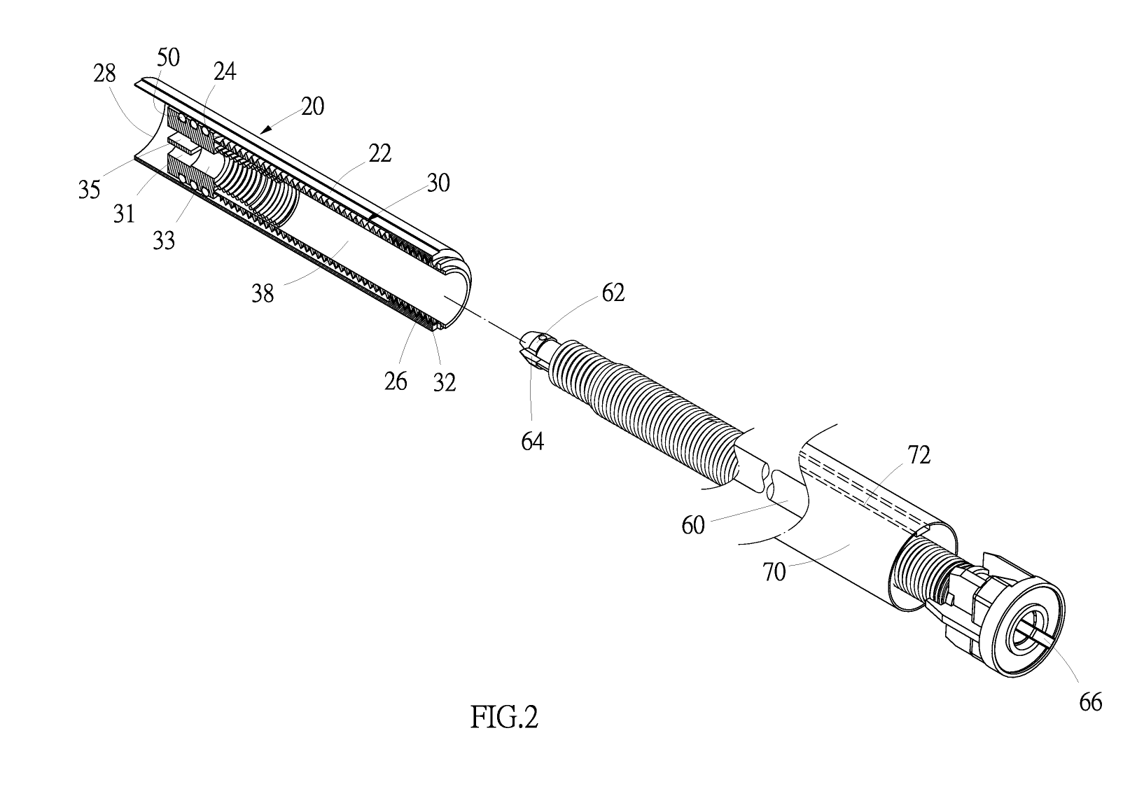

Referring to FIGS. 1 and 2, a reel-damping apparatus 10 includes a first tube 20, a second tube 30, a C-clip 40 and rings 50 according to the preferred embodiment of the present invention. The first tube 20 includes a longitudinal groove 22, a frusto-conical face 24, a thread 26 and an open end 28. The longitudinal groove 22 is made in an external side of the first tube 20. The frusto-conical face 24 and the thread 26 are formed on an internal side of the first tube 20.

The second tube 30 includes a thread 32, annular grooves 34, a stop 35 and three tunnels 31, 33 and 38. The thread 32 and the annular grooves 34 are made on or in an external side of the second tube 30. The annular grooves 34 are located near an end of the second tube 30. The tunnels 31, 33 and 38 are coaxial with one another.

The tunnel 33 is made with a diameter smaller than that of the tunnel 31. The diameter of the tunnel 31 is smaller than that of the tunnel 38. The stop 35 is formed on an internal side of the second tube 30. The stop 35 is in the form of a tab with two ends merged with the internal side of the second tube 30. The stop 35 is located in the tunnel 31.

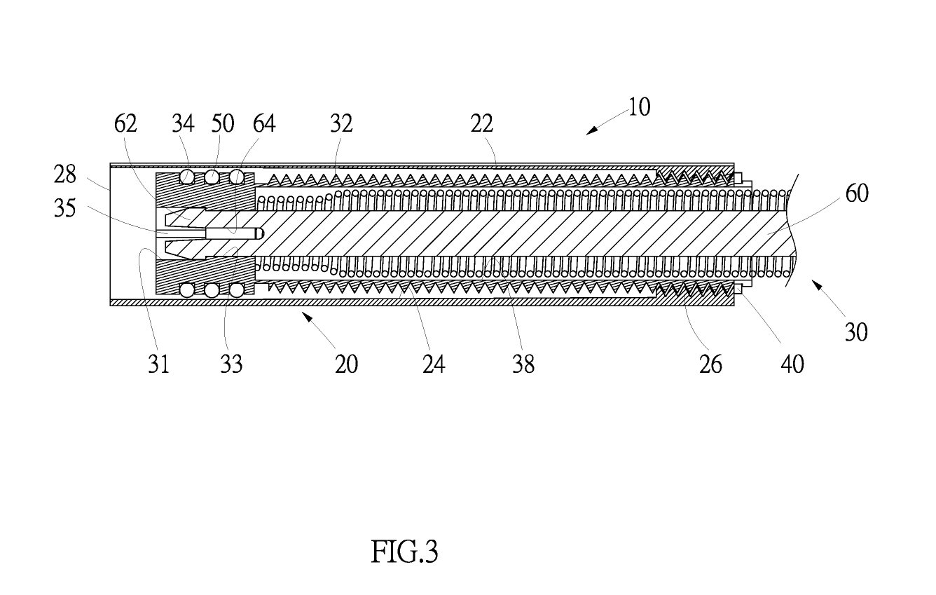

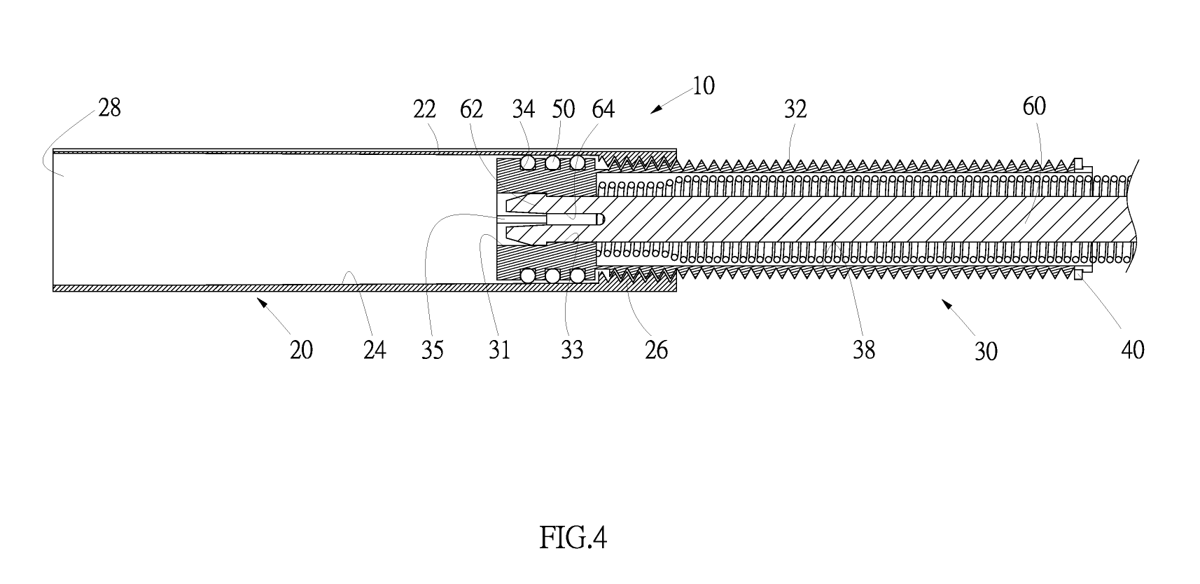

Referring to FIGS. 3 and 4, the rings 50 are placed in the annular grooves 34.

The second tube 30 is inserted in the first tube 20. The first tube 20 is rotatable around the second tube 30. The thread 32 is engaged with the thread 26. The C-clip 37 is engaged with a portion of the thread 32.

Referring to FIG. 2, the second tube 30 is inserted in a reel 70. The longitudinal groove 22 receives a longitudinal tube 72 extending on an internal side of the reel 70. Thus, the second tube 30 is rotated together with the reel 70 when a Roman blind is wound onto or released from the reel 70.

The reel-damping apparatus 10 is used with a bar 60. The bar 60 includes an enlarged head 62 formed at an end and another head 66 formed at an opposite end. The enlarged head 62 includes a slit 64 made therein to increase the flexibility of the enlarged head 62.

The bar 60 is inserted in the second tube 30. The head 62 is placed in the tunnel 31 to prevent movement of the bar 60 in the second tube 30 in a sense of direction. The stop 35 is placed against the head 62 to prevent movement of the bar 60 in the second tube 30 in an opposite sense of direction. Thus, the bar 60 is kept in the second tube 30. The stop 35 is inserted in the slit 64 to avoid rotation of the bar 60 in the second tube 30. The head 66 is inserted in the reel 70.

Due to the engagement of the thread 32 with the thread 26, when the first tube 20 is rotated on the second tube 30, the first tube 20 is moved along the second tube 30 between a first position shown in FIG. 3 and a second position shown in FIG. 4. The first tube 20 is moved into the first position from the second position when the Roman blind is released from the reel 70. The first tube 20 is kept in the first position when the tube 20 is in contact with the C-clip 40. The first position is changeable as the position of the C-clip 40 on the thread 26 is changeable. That is, stroke of the release of the Roman blind from the reel 70 is changeable.

In the first position, the rings 50 are in loose contact with a large end of the frusto-conical face 24. Hence, it is easy to rotate the first tube 20 around the second tube 30. In the second position, the rings 50 are in firm contact with a large end of the frusto-conical face 24. Hence, it is difficult to rotate the first tube 20 around the second tube 30. The first tube 20 is moved into the second position from the first position when the Roman blind is wound onto the reel 70 by a torque spring (not numbered) for example. That is, it gets more difficult to rotate the first tube 20 on the second tube 30 when the Roman blind is wound onto the reel 70. Hence, the reel 70 is damped.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A reel-damping apparatus including:
a first tube including an internal thread and an internal frusto-conical face formed with a small end and a large end;
a second tube including an external thread engaged with the internal thread when the second tube is inserted in the first tube;
a ring mounted on the second tube, wherein the ring is in tighter contact with the first tube against the rotation of the first tube on the second tube as the ring is located at the small end of the frusto-conical face than at the large end of the frusto-conical face.

2. The reel-damping apparatus according to claim 1, further including a C-clip engaged with the external thread for contact with an end of the first tube.

3. The reel-damping apparatus according to claim 1, wherein the internal thread is closer to the small end of the frusto-conical face than the large end of the frusto-conical face.

4. The reel-damping apparatus according to claim 1, wherein the first tube includes a longitudinal groove for receiving a rib of a reel that supports a Roman blind.

5. The reel-damping apparatus according to claim 1, wherein the second tube includes an annular groove for receiving the ring.

6. The reel-damping apparatus according to claim 1, further including a bar formed with an enlarged head, wherein the second tube includes a first tunnel for receiving the enlarged head of the bar, a second tunnel with a diameter smaller than that of the first tunnel, and a third tunnel with a diameter larger than that of the first tunnel.

7. The reel-damping apparatus according to claim 6, wherein the second tube includes a stop formed in the first tunnel to stop the enlarged head of the bar.

8. The reel-damping apparatus according to claim 7, wherein the bar includes a slit in the enlarged head, wherein the stop is in the form of a tab inserted in the slit to prevent the second tube from rotation on the bar.
